(19) United States
(12) Patent Application Publication
(10) Pub. No.: US 2025/0175896 A1
(43) Pub. Date: May 29, 2025

(54) POSITIONING PROCESSING METHOD AND APPARATUS, DEVICE, AND READABLE STORAGE MEDIUM

(71) Applicant: VIVO MOBILE COMMUNICATION CO., LTD., Dongguan (CN)

(72) Inventor: Ye SI, Dongguan (CN)

(73) Assignee: VIVO MOBILE COMMUNICATION CO., LTD., Dongguan (CN)

(21) Appl. No.: 19/037,283

(22) Filed: Jan. 27, 2025

Related U.S. Application Data
(63) Continuation of application No. PCT/CN2023/109577, filed on Jul. 27, 2023.

(30) Foreign Application Priority Data
Aug. 2, 2022 (CN) 202210924886.3

(51) Int. Cl. H04W 52/02; H04W 64/00

(52) U.S. Cl. CPC H04W 52/0212; H04W 64/00

(57) ABSTRACT

This application provides a positioning processing method and apparatus, a device, and a readable storage medium. The positioning processing method on a first device side includes: receiving at least one of a first location request or first indication information; and initiating a positioning procedure based on at least one of the first location request or the first indication information. The first location request includes information used to indicate a requirement for power consumption positioning of a first terminal. The first indication information includes information used to indicate a terminal characteristic of the first terminal in response to the requirement for power consumption positioning. The first device is a first network device.

### CROSS-REFERENCE TO RELATED APPLICATIONS

This application is a continuation of International Application No. PCT/CN 2023/109577, filed on Jul. 27, 2023, which claims priority to Chinese Patent Application No. 202210924886.3, filed on Aug. 2, 2022. The entire contents of each of the above-referenced applications are expressly incorporated herein by reference.

### TECHNICAL FIELD

This application pertains to the field of communication technologies, and specifically, to a positioning processing method and apparatus, a device, and a readable storage medium.

### BACKGROUND

To reduce power consumption during terminal positioning, use cases and requirements for Low Power High Accuracy Positioning (LPHAP) in industrial internet of things scenarios are introduced in a related technology. Currently, a network device may initiate a positioning procedure based on a first location request of a terminal or a Location Services (LCS) entity. However, the network device cannot determine, based on an existing location request, whether to initiate a positioning procedure corresponding to a requirement for power consumption positioning. Consequently, the network device cannot accurately initiate the positioning procedure corresponding to the requirement for power consumption positioning.

### SUMMARY

Embodiments of this application provide a positioning processing method and apparatus, a device, and a readable storage medium.

According to a first aspect, a positioning processing method is provided. The method includes:
receiving, by a first device, at least one of a first location request and first indication information, where the first location request includes information used to indicate a requirement for power consumption positioning of a first terminal, the first indication information includes information used to indicate a terminal characteristic of the first terminal in a case of the requirement for power consumption positioning, and the first device is a first network device; and
initiating, by the first device, a positioning procedure based on at least one of the first location request and the first indication information.

According to a second aspect, a positioning processing apparatus is provided and is applied to a first device. The apparatus includes:
a first receiving module, configured to receive at least one of a first location request and first indication information, where the first location request includes information used to indicate a requirement for power consumption positioning of a first terminal, the first indication information includes information used to indicate a terminal characteristic of the first terminal in a case of the requirement for power consumption positioning, and the first device is a first network device; and
an initiation module, configured to initiate a positioning procedure based on at least one of the first location request and the first indication information.

According to a third aspect, a positioning processing method is provided. The method includes:

sending, by a second device, at least one of a first location request and first indication information to a first device, where the first location request includes information used to indicate a requirement for power consumption positioning of a first terminal, the first indication information includes information used to indicate a terminal characteristic of the first terminal in a case of the requirement for power consumption positioning, the first device is a first network device, and the second device is the first terminal, a location services LCS entity, a second network device, or a third network device.

According to a fourth aspect, a positioning processing apparatus is provided and is applied to a second device. The apparatus includes:

a sending module, configured to send at least one of a first location request and first indication information to a first device, where the first location request includes information used to indicate a requirement for power consumption positioning of a first terminal, the first indication information includes information used to indicate a terminal characteristic of the first terminal in a case of the requirement for power consumption positioning, the first device is a first network device, and the second device is the first terminal, a location services LCS entity, or a network device different from the first network device.

According to a fifth aspect, a first device is provided. The first device includes a processor and a memory. The memory stores a program or instructions capable of being run on the processor, and when the program or the instructions are executed by the processor, the steps of the method according to the first aspect are implemented.

According to a sixth aspect, a first device is provided. The first device includes a processor and a communication interface. The communication interface is configured to receive at least one of a first location request and first indication information, where the first location request includes information used to indicate a requirement for power consumption positioning of a first terminal, the first indication information includes information used to indicate a terminal characteristic of the first terminal in a case of the requirement for power consumption positioning, and the first device is a first network device. The processor or the communication interface is configured to initiate a positioning procedure based on at least one of the first location request and the first indication information.

According to a seventh aspect, a second device is provided. The second device includes a processor and a memory. The memory stores a program or instructions capable of being run on the processor, and when the program or the instructions are executed by the processor, the steps of the method according to the third aspect are implemented.

According to an eighth aspect, a second device is provided and includes a processor and a communication interface. The communication interface is configured to send at least one of a first location request and first indication information to a first device, where the first location request includes information used to indicate a requirement for power consumption positioning of a first terminal, the first indication information includes information used to indicate a terminal characteristic of the first terminal in a case of the requirement for power consumption positioning, the first device is a first network device, and the second device is the first terminal, a location services LCS entity, or a network device different from the first network device.

According to a ninth aspect, a communication system is provided and includes a first device and a second device. The first device may be configured to perform the steps of the method according to the first aspect, and the second device may be configured to perform the steps of the method according to the third aspect.

According to a tenth aspect, a readable storage medium is provided. The readable storage medium stores a program or instructions, and when the program or the instructions are executed by a processor, the steps of the method according to the first aspect or the steps of the method according to the third aspect are implemented.

According to an eleventh aspect, a chip is provided. The chip includes a processor and a communication interface. The communication interface is coupled to the processor. The processor is configured to run a program or instructions to implement the method according to the first aspect or the method according to the third aspect.

According to a twelfth aspect, a computer program/program product is provided. The computer program/program product is stored in a storage medium. The computer program/program product is executed by at least one processor to implement the steps of the method according to the first aspect or the steps of the method according to the third aspect.

In the embodiments of this application, the first device receives at least one of the first location request and the first indication information, where the first location request includes information used to indicate the requirement for power consumption positioning of the first terminal, and the first indication information includes information used to indicate the terminal characteristic of the first terminal in the case of the requirement for power consumption positioning In this way, the first device can accurately initiate the positioning procedure corresponding to the requirement for power consumption positioning based on the first location request and/or the first indication information. Because the first device can accurately initiate the positioning procedure corresponding to the requirement for power consumption positioning, the terminal can accurately perform positioning, thereby reducing positioning power consumption of the terminal.

### BRIEF DESCRIPTION OF DRAWINGS

FIG. 1 is a block diagram of a wireless communication system according to an embodiment of this application;

FIG. 2 is flowcharts of a positioning processing method according to an embodiment of this application;

FIG. 2a is a specific example diagram of a positioning processing procedure according to an embodiment of this application;

FIG. 2b is another specific example diagram of a positioning processing procedure according to an embodiment of this application;

FIG. 2c is another specific example diagram of a positioning processing procedure according to an embodiment of this application;

FIG. 3 is a structural diagram of a positioning processing apparatus according to an embodiment of this application;

FIG. 4 is a flowchart of a positioning processing method according to an embodiment of this application;

FIG. 5 is a structural diagram of a positioning processing apparatus according to an embodiment of this application;

FIG. 6 is a structural diagram of a communication device according to an embodiment of this application;

FIG. 7 is a schematic diagram of a hardware structure of a network device according to an embodiment of this application;

FIG. 8 is a schematic diagram of a hardware structure of another network device according to an embodiment of this application; and

FIG. 9 is a schematic diagram of a hardware structure of a terminal according to an embodiment of this application.

### DETAILED DESCRIPTION

The technical solutions in the embodiments of this application are clearly described below with reference to the accompanying drawings in the embodiments of this application. Clearly, the described embodiments are some but not all of the embodiments of this application. All other embodiments obtained by a person of ordinary skill in the art based on the embodiments of this application shall fall within the protection scope of this application.

The terms “first”, “second”, and the like in the specification and the claims of this application are used to distinguish between similar objects, and are not used to describe a specific order or sequence. It should be understood that the terms used in such a manner are interchangeable in proper situations, so that the embodiments of this application can be implemented in an order other than those illustrated or described herein. In addition, objects distinguished by using “first” and “second” are usually of a same type, and a quantity of objects is not limited. For example, there may be one or more first objects. Furthermore, in the specification and the claims, “and/or” indicates at least one of connected objects, and the character “/” usually indicates an “or” relationship between associated objects.

It should be noted that the technologies described in the embodiments of this application are not limited to a Long Term Evolution (LTE)/LTE-Advanced (LTE-A) system, and may be further used in other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and another system. The terms “system” and “network” in the embodiments of this application are often interchangeably used. The described technologies may be used in the systems and radio technologies described above, and may be further used in other systems and radio technologies. A New Radio (NR) system is described in the following descriptions for example purposes, and NR terms are used in most of the following descriptions. However, these technologies may be further applied to applications other than NR system applications, for example, a 6th Generation (6G) communication system.

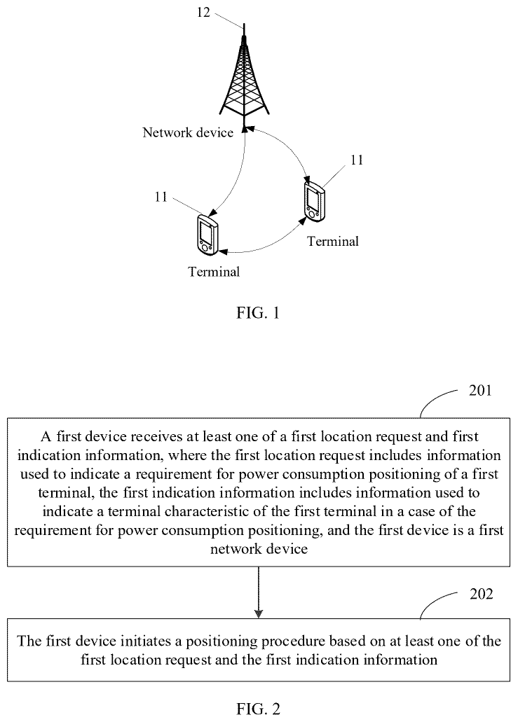

FIG. 1 is a block diagram of a wireless communication system to which an embodiment of this application may be applied. The wireless communication system includes a terminal 11 and a network device 12. The terminal 11 may be a mobile phone, a tablet personal computer, a laptop computer, or referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a vehicle-mounted device (Vehicle User Equipment (VUE)), a Pedestrian User Equipment (PUE), a smart home (a home device with a wireless communication function, for example, a refrigerator, a television, a washing machine, or a piece of furniture), a game console, a Personal Computer (PC), a teller machine, a self-service machine, or another terminal side device. The wearable device includes a smartwatch, a smart band, a smart headset, smart glasses, smart jewelry (a smart bracelet, a smart hand chain, a smart ring, a smart necklace, a smart anklet, a smart foot chain, or the like), a smart wristband, smart clothing, or the like. It should be noted that a specific type of the terminal 11 is not limited in the embodiments of this application. The network device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. Provided that same technical effects are achieved, the base station is not limited to a specific technical vocabulary. It should be noted that in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Location Management Function (LMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that in the embodiments of this application, only a core network device in the NR system is used as an example for description, and a specific type of the core network device is not limited.

With reference to the accompanying drawings, the positioning processing method, the positioning processing apparatus, the first device, the second device, and the storage medium provided in the embodiments of this application are described below in detail by using some embodiments and application scenarios.

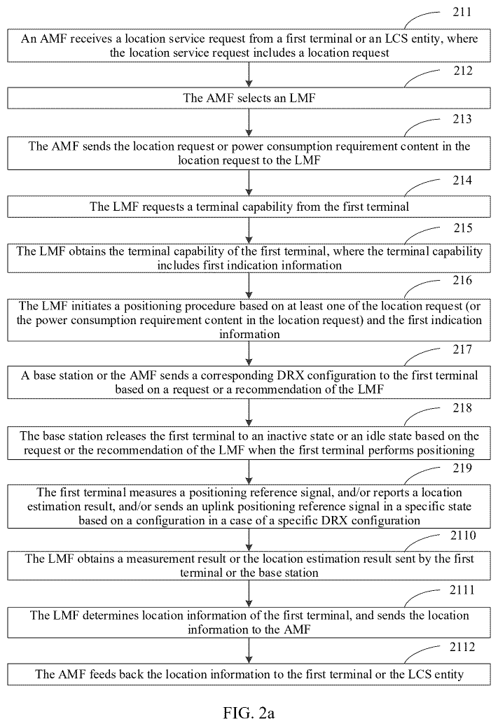

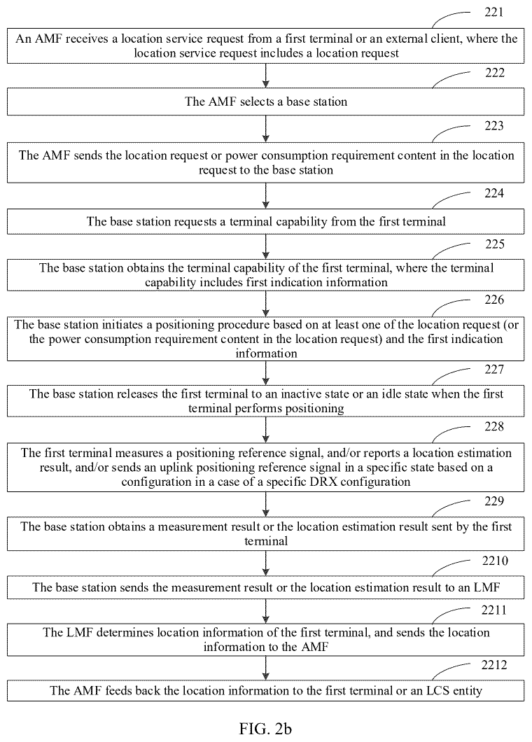

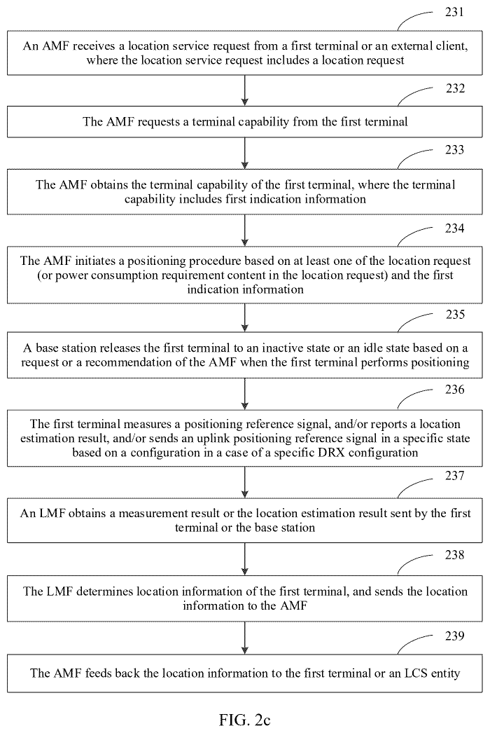

FIG. 2 is a flowchart of a positioning processing method according to an embodiment of this application. As shown in FIG. 2, the positioning processing method includes the following steps.

Step 201: A first device receives at least one of a first location request and first indication information, where the first location request includes information used to indicate a requirement for power consumption positioning of a first terminal, the first indication information includes information used to indicate a terminal characteristic of the first terminal in a case of the requirement for power consumption positioning, and the first device is a first network device.

Step 202: The first device initiates a positioning procedure based on at least one of the first location request and the first indication information.

The information that is included in the first location request and that is used to indicate the requirement for power consumption positioning of the first terminal may be a power consumption parameter used by the first terminal to perform positioning. For example, the first location request may include a first power consumption parameter, and the first power consumption parameter is less than or greater than a reference power consumption parameter. In an example, the first power consumption parameter is less than the reference power consumption parameter. In this example, the requirement for power consumption positioning may be understood as a low power positioning requirement. Correspondingly, the first location request may be understood as a low power location request.

The first device may receive at least one of the first location request and the first indication information. In a case in which the first device receives the first location request and the first indication information, the first location request and the first indication information may be from two different devices, or may be from a same device. An example in which the first location request and the first indication information are from a same device is used. The first location request and the first indication information may be sent by using a same message, which is referred to as a first message in this embodiment of this application, or may be respectively sent by using different messages.

In an example, the first location request may be included in an LCS message, an LTE Positioning Protocol (LPP) message, or interface signaling between network devices, and the first indication information may be included in an LPP message, a Radio Resource Control (RRC) message, a Non-access stratum (NAS) message, or interface signaling between network devices.

In this embodiment of this application, the first device receives at least one of the first location request and the first indication information, where the first location request includes information used to indicate the requirement for power consumption positioning of the first terminal, and the first indication information includes information used to indicate the terminal characteristic of the first terminal in the case of the requirement for power consumption positioning. In this way, the first device can accurately initiate the positioning procedure corresponding to the requirement for power consumption positioning based on the first location request and/or the first indication information. Because the first device can accurately initiate the positioning procedure corresponding to the requirement for power consumption positioning, the terminal can accurately perform positioning, thereby reducing positioning power consumption of the terminal.

The positioning processing method in this embodiment of this application may be applied to a case in which the first terminal performs positioning corresponding to the requirement for power consumption positioning in a non-connected state.

In some embodiments, that a first device receives at least one of a first location request and first indication information includes:
The first device receives the first location request and the first indication information from a second device, where the second device is the first terminal, a location services LCS entity, or a second network device; or
the first device receives the first location request from a third device, and the first device receives the first indication information from a fourth device, where the third device is the first terminal, an LCS entity, or a third network device, and the fourth device is the first terminal, an LCS entity, or a fourth network device.

Herein, the LCS entity may include an LCS entity built in a 5G core network, an external client, or an LCS application.

In this implementation, both the first location request and the first indication information may be from the second device, that is, the first location request and the first indication information are from a same device. In some embodiments, the first location request and the first indication information may be from the third device and the fourth device, that is, the first location request and the first indication information are from different devices.

For a case in which the first location request and the first indication information are respectively from the third device and the fourth device, for example, the third device is a network device, and the fourth device is a terminal device; the third device is a network device, and the fourth device is another network device; or the third device is a terminal device, and the fourth device is a network device.

Each of the second device, the third device, and the fourth device may be the first terminal, an LCS entity, or a network device.

For a case in which the second device, the third device, and the fourth device are network devices, in an example, when the first device is an AMF, the second device, the third device, or the fourth device may be a Gateway Mobile Location Centre (GMLC); when the first device is an LMF, the second device, the third device, or the fourth device may be an AMF; or when the first device is a base station, the second device, the third device, or the fourth device may be an LMF or an AMF.

It should be noted that naming of the first network device and the second network device is used to distinguish between the first device and the second device when both the first device and the second device are network devices. Naming of the first network device and the third network device is used to distinguish between the first device and the third device when both the first device and the third device are network devices. Naming of the first network device and the fourth network device is used to distinguish between the first device and the fourth device when both the first device and the fourth device are network devices. Naming of the third network device and the fourth network device is used to distinguish between the third device and the fourth device when the first location request and the first indication information are respectively from the third device and the fourth device.

In this embodiment of this application, an execution body that initiates the positioning procedure may be an AMF, an LMF, or a base station. For example, the following cases may be included:
Manner 1: The AMF receives the first location request sent by the first terminal, an LCS entity, or a GMLC, and/or the AMF receives the first indication information sent by the first terminal, the LCS entity, or the GMLC, and the AMF initiates the positioning procedure.
Manner 2: The LMF receives the first location request sent by the first terminal, an LCS entity, or an AMF, and/or the LMF receives the first indication information sent by the first terminal, the LCS entity, or the AMF, and the LMF initiates the positioning procedure.
Manner 3: The base station receives the first location request sent by the first terminal, an LCS entity, an LMF, or an AMF, and/or the base station receives the first indication information sent by the first terminal, the LCS entity, the LMF, or the AMF, and the base station initiates the positioning procedure.

It should be noted that regardless of whether the positioning procedure is initiated by the AMF, the LMF, or the base station, a network device involved in a subsequent positioning procedure is not limited to a network device that initiates the positioning procedure, and a plurality of network devices and the first terminal may jointly participate in the subsequent positioning procedure.

A related implementation of initiating the positioning procedure is described in detail later. A related implementation of the first location request and a related implementation of the first indication information in this embodiment of this application are first described below.

In some embodiments, the first location request includes at least one of the following: a service enable identifier for power consumption positioning;
battery information of the first terminal;
positioning service information of the first terminal;
power consumption information of the first terminal;
a positioning parameter for each time of positioning by the first terminal; and
a communication parameter for an overall communication service of the first terminal.

In an example, if the first location request includes the service enable identifier for power consumption positioning, it indicates that the first terminal requests a positioning service corresponding to the requirement for power consumption positioning. Otherwise, it indicates that the first terminal requests a normal positioning service.

In some embodiments, the battery information of the first terminal includes at least one of the following:
a battery capacity parameter of the first terminal; and
a battery life requirement parameter of the first terminal.

In an example, the battery capacity parameter of the first terminal may be 4500 mAh, and the battery life requirement parameter of the first terminal may be 6-12 months.

In some embodiments, the positioning service information of the first terminal includes at least one of the following:
a positioning service level parameter of the first terminal; and
positioning service type indication information of the first terminal.

For example, the positioning service level parameter may be specified in a protocol. For example, a plurality of positioning service levels are specified in the protocol, and each level includes at least one of a specific accuracy requirement, a delay requirement, a power consumption requirement, and a positioning availability requirement. When the first location request indicates a service level corresponding to a current service, a corresponding positioning service requirement may be clearly indicated.

In an example, the positioning service type indication information of the first terminal may indicate that a positioning service type of the first terminal is an LPHAP service type, or indicate that a positioning service type of the first terminal is a specific service type in LPHAP.

In some embodiments, the power consumption information of the first terminal includes at least one of the following:
a power level parameter of the first terminal; and
a parameter of a ratio of positioning power consumption of the first terminal to total power consumption of the first terminal.

In an example, the power level parameter of the first terminal may be a specific power level, an upper or lower power level limit, or a power level range. A plurality of power levels may be specified in a protocol (or preconfigured by a network device), and the first location request indicates a specific power level. The power level parameter of the first terminal may be a power level only for the positioning service, or may be a power level for the overall communication service that is of the first terminal and that includes the positioning service.

In an example, the parameter of the ratio of the positioning power consumption of the first terminal to the total power consumption of the first terminal may be a ratio of the positioning service of the first terminal to the total power consumption (or total power consumption for the communication service) of the first terminal, or may be an upper limit of a ratio of the positioning service of the first terminal to the total power consumption (or total power consumption for the communication service) of the first terminal.

In some embodiments, the positioning parameter for each time of positioning by the first terminal includes at least one of the following:
a power consumption parameter for each time of positioning by the first terminal;
a peak power parameter for each time of positioning by the first terminal; and
an average power parameter for each time of positioning by the first terminal.

In an example, the power consumption parameter (or referred to as an energy consumption parameter) for each time of positioning by the first terminal may be that average power consumption for each time of positioning or one time of positioning (per position fix) by the first terminal is less than a threshold, for example, 20 mJ (millijoule), or average power consumption for one time of positioning by the first terminal is less than a threshold.

The peak power parameter and the average power parameter may be absolute power or relative power. A unit of the relative power may be expressed in terms of a power unit, where 1 power unit is power of the terminal under a specific condition, for example, baseline power consumption of the terminal, power of the terminal in a deep sleep state, baseline power consumption of the terminal in an idle state or an inactive state, power of the terminal in a standby state, or power of the terminal in an off state. In an example, the peak power parameter for each time of positioning (or one time of positioning) by the first terminal may be an upper peak power limit, for example, 200 mW (milliwatt). The average power parameter for each time of positioning (or one time of positioning) by the first terminal may be an upper average power limit, for example, 20 mW.

In some embodiments, the communication parameter for the overall communication service of the first terminal includes at least one of the following:
a power consumption parameter for the overall communication service of the first terminal;
a peak power parameter for the overall communication service of the first terminal; and
an average power parameter for the overall communication service of the first terminal.

The overall communication service includes not only the positioning service, but also another conventional communication service such as data receiving/sending.

In addition, the first location request may further include at least one of a horizontal accuracy requirement, a vertical accuracy requirement, a positioning interval, a duty cycle, and a delay requirement.

In an example, requirements of the first location request in this embodiment of this application may be as follows: Positioning accuracy is less than 1 meter, the positioning service level is a service level 3, the positioning service interval is 15-30 seconds, and a battery life is 6-12 months.

In some embodiments, the first indication information includes at least one of the
information used to indicate a terminal characteristic that the first terminal performs positioning measurement in the non-connected state;
information used to indicate a terminal characteristic that the first terminal performs positioning reporting in the non-connected state;
information used to indicate a terminal characteristic that the first terminal sends an uplink positioning reference signal in the non-connected state; and
information used to indicate a terminal characteristic that a type of the first terminal is a low power high accuracy positioning LPHAP type or an internet of things IoT type.

In an example, the first terminal may request or recommend, by using the first indication information, performing positioning measurement in the non-connected state (including the inactive state and the idle state). In this case, it may be understood that the first indication information includes information used to indicate the terminal characteristic that the first terminal performs positioning measurement in the non-connected state.

The first terminal may request or recommend, by using the first indication information, performing positioning reporting in the non-connected state. In this case, it may be understood that the first indication information includes information used to indicate the terminal characteristic that the first terminal performs positioning reporting in the non-connected state.

The first terminal may request or recommend, by using the first indication information, sending the uplink positioning reference signal in the non-connected state. In this case, it may be understood that the first indication information includes information used to indicate the terminal characteristic that the first terminal sends the uplink positioning reference signal in the non-connected state.

The first terminal may indicate, by using the first indication information, that the type of the first terminal is the LPHAP type or the IoT type. In this case, it may be understood that the first indication information includes information used to indicate the terminal characteristic that the type of the first terminal is the LPHAP type or the IoT type.

In some embodiments, the first indication information is included in terminal capability information (UE Capability information) or terminal assistance information (UE assistance information).

In some embodiments, the first indication information is indication information corresponding to the first terminal on a first frequency band, and the first indication information is indicated once on each frequency band; or
the first indication information is indication information corresponding to the first terminal in a first frequency range, and the first indication information is indicated once in each frequency range; or
the first indication information is indication information corresponding to a case in which the first terminal uses a first positioning method, and the first indication information is indicated once for each positioning method; or
the first indication information is indication information corresponding to a case in which the first terminal uses a first positioning method on a first frequency band, and the first indication information is indicated once for each positioning method on each frequency band; or
the first indication information is indication information corresponding to a case in which the first terminal uses a first positioning method in a first frequency range, and the first indication information is indicated once for each positioning method in each frequency range.

The first indication information is indicated once for each terminal.

In this implementation, the first terminal may send the terminal characteristic indication information of the first terminal on each frequency band (per band), the first terminal may send the terminal characteristic indication information of the first terminal in each frequency range (per FR), the first terminal may send the terminal characteristic indication information of the first terminal when using each positioning method, or the first terminal may send the terminal characteristic indication information of the first terminal on each frequency band or in each frequency range when using each positioning method. In this way, the terminal characteristic indication information can be more accurate, so that positioning by the first terminal can better meet the requirement for power consumption positioning of the first terminal.

The related implementation of the first location request and the related implementation of the first indication information in this embodiment of this application are described above. The related implementation of initiating the positioning procedure in this embodiment of this application is described below by using the first device that is an AMF, an LMF, or a base station as the execution body.

Manner 1: The first device is an AMF.

That the first device initiates a positioning procedure includes at least one of the
The first device sends at least one of a second location request and second indication information to a fifth device, where the second location request includes information used to indicate the requirement for power consumption positioning of the first terminal, the second indication information includes information used to indicate the terminal characteristic of the first terminal in the case of the requirement for power consumption positioning, and the fifth device includes an LMF or a base station;
the first device sends first configuration information to the first terminal, where the first configuration information includes at least one of configuration information of a Core Network Discontinuous Reception (CN DRX) cycle and configuration information of a Core Network extended Discontinuous Reception (CN eDRX) cycle;
the first device sends a third message to the base station, where the third message is used to recommend at least one of configuration information of a Radio Access Network Discontinuous Reception (RAN DRX) cycle and configuration information of a Radio Access Network extended Discontinuous Reception (RAN eDRX) cycle to the base station; and
the first device sends a fourth message to the base station, where the fourth message is used to recommend a corresponding RRC state during positioning by the first terminal to the base station.

In this implementation, after the AMF receives the first location request and/or the first indication information, the AMF may send the second location request and/or the second indication information to the LMF or the base station, to synchronize a case in which the first terminal has the requirement for power consumption positioning to the LMF or the base station.

The AMF may further configure appropriate CN DRX and/or CN eDRX for the first terminal.

The AMF may further recommend an appropriate RAN DRX and/or RAN eDRX configuration to the base station, to assist the base station in configuring the RAN DRX and/or the RAN eDRX for the first terminal.

The AMF may further recommend the RRC state during positioning, for example, positioning measurement, positioning reporting, or sending of an uplink positioning reference signal, by the first terminal to the base station.

In some embodiments, the method further includes:
The first device sends a fifth message to the base station, where the fifth message includes at least one of CN DRX and CN eDRX configured by the first device for the first terminal; and
the first device receives a sixth message sent by the base station, where the sixth message includes at least one of RAN DRX and RAN eDRX configured by the base station for the first terminal.

In this implementation, if the AMF configures appropriate CN DRX and/or CN eDRX for the first terminal, the AMF may further send a message that includes the CN DRX and/or the CN eDRX configured by the AMF for the first terminal to the base station, to synchronize configuration information of the CN DRX and/or the CN eDRX to the base station.

If the AMF recommends appropriate RAN DRX and/or RAN eDRX to the base station, the AMF may further receive a message that is sent by the base station and that includes the RAN DRX and/or the RAN eDRX configured by the base station for the first terminal, to synchronize configuration information of the RAN DRX and/or the RAN eDRX to the AMF.

Manner 2: The first device is an LMF.

That the first device initiates a positioning procedure includes at least one of the following:
The first device sends at least one of a third location request and third indication information to a base station, where the third location request includes information used to indicate the requirement for power consumption positioning of the first terminal, and the third indication information includes information used to indicate the terminal characteristic of the first terminal in the case of the requirement for power consumption positioning;
the first device sends an eighth message to an AMF, where the eighth message is used to request the AMF to configure at least one of CN DRX and CN eDRX for the first terminal;
the first device sends a ninth message to the AMF, where the ninth message is used to recommend at least one of configuration information of CN DRX and configuration information of CN eDRX to the AMF;
the first device sends a tenth message to the base station, where the tenth message is used to request the base station to configure at least one of RAN DRX and RAN eDRX for the first terminal;
the first device sends an eleventh message to the base station, where the eleventh message is used to recommend at least one of configuration information of RAN DRX and configuration information of RAN eDRX to the base station;
the first device sends a twelfth message to a sixth device, where the twelfth message includes at least one of downlink positioning reference signal configuration information, positioning reporting configuration information, and positioning processing method configuration information that are determined by the first device, and the sixth device includes at least one of a base station and the first terminal;
the first device sends a thirteenth message to the base station, where the thirteenth message is used to recommend uplink positioning reference signal configuration information to the base station; and
the first device sends a fourteenth message to the base station, where the fourteenth message is used to recommend a corresponding RRC state during positioning by the first terminal to the base station.

In this implementation, after the LMF receives the first location request and/or the first indication information, the LMF may send the third location request and/or the third indication information to the base station, to synchronize a case in which the first terminal has the requirement for power consumption positioning to the base station.

The LMF may further request the AMF to configure appropriate CN DRX and/or CN eDRX for the first terminal.

The LMF may further recommend an appropriate CN DRX and/or CN eDRX configuration to the AMF, to assist the AMF in configuring the CN DRX and/or the CN eDRX for the first terminal.

The LMF may further request the base station to configure appropriate RAN DRX and/or RAN eDRX for the first terminal.

The LMF may further recommend an appropriate RAN DRX and/or RAN eDRX configuration to the base station, to assist the base station in configuring the RAN DRX and/or the RAN eDRX for the first terminal.

The LMF may further determine an appropriate DownLink Positioning Reference Signal (DL-PRS) configuration, for example, a PRS configuration for the requirement for power consumption positioning, for example, a relatively large PRS period, and send the downlink positioning reference signal configuration to the base station and/or the first terminal.

The LMF may further determine an appropriate positioning reporting configuration, for example, a reporting period and a reporting response time, and send the positioning reporting configuration to the first terminal.

The LMF may further determine an appropriate positioning method based on the terminal characteristic of the first terminal and/or the location request, and send a positioning method configuration to the first terminal.

The LMF may further recommend an appropriate uplink positioning reference signal configuration to the base station, to assist the base station in configuring an uplink positioning reference signal for the first terminal.

The LMF may further recommend the RRC state during positioning, for example, positioning measurement, positioning reporting, or sending of an uplink positioning reference signal, by the first terminal to the base station.

In some embodiments, the method further includes at least one of the following:
The first device receives a fifteenth message sent by the AMF, where the fifteenth message includes at least one of CN DRX and CN eDRX configured by the AMF for the first terminal; and
the first device receives a sixteenth message sent by the base station, where the sixteenth message includes at least one of RAN DRX and RAN eDRX configured by the base station for the first terminal.

In this implementation, if the LMF requests the CN DRX and/or the CN eDRX from or recommends the CN DRX and/or the CN eDRX to the AMF, the LMF may further receive a message that is sent by the AMF and that includes the CN DRX and/or the CN eDRX configured by the AMF for the first terminal, to synchronize configuration information of the CN DRX and/or the CN eDRX to the LMF.

If the LMF requests the RAN DRX and/or the RAN eDRX from or recommends the RAN DRX and/or the RAN eDRX to the base station, the LMF may further receive a message that is sent by the base station and that includes the RAN DRX and/or the RAN eDRX configured by the base station for the first terminal, to synchronize configuration information of the RAN DRX and/or the RAN eDRX to the LMF.

Manner 3: The first device is a base station.

That the first device initiates a positioning procedure includes at least one of the

The first device sends a seventeenth message to an AMF, where the seventeenth message is used to request the AMF to configure at least one of CN DRX and CN eDRX for the first terminal;
the first device sends an eighteenth message to the AMF, where the eighteenth message is used to recommend at least one of configuration information of CN DRX and configuration information of CN eDRX to the AMF;
the first device sends second configuration information to the first terminal, where the second configuration information includes at least one of configuration information of RAN DRX and configuration information of RAN eDRX;
the first device sends third configuration information to the first terminal, where the third configuration information includes at least one of downlink positioning reference signal configuration information, downlink positioning reference signal measurement window configuration information, and uplink positioning reference signal configuration information; and
the first device switches an RRC state of the first terminal to an idle state or an inactive state.

In this implementation, the base station may request the AMF to configure appropriate CN DRX and/or CN eDRX for the first terminal.

The base station may further recommend an appropriate CN DRX and/or CN eDRX configuration to the AMF, to assist the AMF in configuring the CN DRX and/or the CN eDRX for the first terminal.

The base station may further configure appropriate RAN DRX and/or RAN eDRX for the first terminal.

The base station may further configure an appropriate uplink positioning reference signal for the first terminal.

The base station may further configure an appropriate downlink positioning reference signal measurement window (or a processing window) for the first terminal.

The base station may further configure an appropriate uplink positioning reference signal for the first terminal.

When the first terminal performs positioning, the base station may further release the first terminal, so that the first terminal enters a corresponding non-connected state (for example, the idle state or the inactive state).

In some embodiments, the method further includes:
The first device receives a nineteenth message sent by the AMF, where the nineteenth message includes at least one of CN DRX and CN eDRX configured by the AMF for the first terminal; and
the first device sends a twentieth message to an LMF, where the twentieth message includes at least one of RAN DRX and RAN eDRX configured by the first device for the first terminal.

In this implementation, if the base station requests the CN DRX and/or the CN eDRX from or recommends the CN DRX and/or the CN eDRX to the AMF, the base station may further receive a message that is sent by the AMF and that includes the CN DRX and/or the CN eDRX configured by the AMF for the first terminal, to synchronize configuration information of the CN DRX and/or the CN eDRX to the base station.

If the base station configures appropriate RAN DRX and/or RAN eDRX for the first terminal, the base station may further send a message that includes the RAN DRX and/or RAN eDRX configured by the base station for the first terminal to the LMF, to synchronize configuration information of the RAN DRX and/or the RAN eDRX to the LMF.

The related implementation of initiating the positioning procedure in this embodiment of this application is described above.

A specific embodiment is provided below. As shown in FIG. 2a, this embodiment includes the following steps.

Step 211: An AMF receives a location service request from a first terminal or an LCS entity, where the location service request includes a location request.

Step 212: The AMF selects an LMF.

Step 213: The AMF sends the location request or power consumption requirement content in the location request to the LMF. Correspondingly, the LMF obtains the location request or the power consumption requirement content in the location request.

For example, there is step 214: The LMF requests a terminal capability from the first terminal.

For example, there is step 215: The LMF obtains the terminal capability of the first terminal, where the terminal capability includes first indication information.

Step 216: The LMF initiates a positioning procedure based on at least one of the location request (or the power consumption requirement content in the location request) and the first indication information. For example, that the LMF initiates a positioning procedure includes at least one of the following procedures, and there is no order between the following procedures:

The LMF requests the AMF to configure appropriate CN DRX and/or CN eDRX for the first terminal. In some embodiments, the LMF recommends an appropriate CN DRX and/or CN eDRX configuration to the AMF, to assist the AMF in configuring the CN DRX and/or the CN eDRX for the first terminal.

The LMF requests a base station to configure appropriate RAN DRX and/or RAN eDRX for the first terminal. In some embodiments, the LMF recommends an appropriate RAN DRX and/or RAN eDRX configuration to a base station, to assist the base station in configuring the RAN DRX and/or the RAN eDRX for the first terminal.

The LMF determines an appropriate downlink positioning reference signal configuration, for example, a PRS configuration with low power consumption, for example, a relatively large PRS period, and sends the downlink positioning reference signal configuration to the base station and/or the first terminal.

The LMF determines an appropriate positioning reporting configuration, for example, a reporting period and a reporting response time, and sends the positioning reporting configuration to the first terminal.

The LMF determines an appropriate positioning method based on a terminal characteristic of the first terminal and/or the location request, and sends a positioning method configuration to the first terminal.

The LMF recommends an appropriate uplink positioning reference signal configuration to the base station, to assist the base station in configuring an uplink positioning reference signal for the first terminal.

The LMF recommends an RRC state during positioning, for example, positioning measurement, positioning reporting, or sending of an uplink positioning reference signal, by the first terminal to the base station.

For example, there is step 217: The base station or the AMF sends a corresponding DRX configuration to the first terminal based on a request or a recommendation of the LMF.

For example, there is step 218: The base station releases the first terminal to an inactive state or an idle state based on the request or the recommendation of the LMF when the first terminal performs positioning.

Step 219: The first terminal measures a positioning reference signal, and/or reports a location estimation result, and/or sends an uplink positioning reference signal in a specific state (for example, the idle or inactive state) based on a configuration in a case of a specific DRX configuration (for example, after at least one of CN DRX, CN eDRX, RAN DRX, and RAN eDRX is configured).

Step 2110: The LMF obtains a measurement result or the location estimation result sent by the first terminal or the base station.

Step 2111: The LMF determines location information of the first terminal, and sends the location information to the AMF.

Step 2112: The AMF feeds back the location information to the first terminal or the LCS entity.

In conclusion, in this embodiment of this application, through the foregoing implementation, the first device may accurately initiate the positioning procedure corresponding to the requirement for power consumption positioning based on the first location request and/or the first indication information. Because the first device can accurately initiate the positioning procedure corresponding to the requirement for power consumption positioning, the terminal can accurately perform positioning, thereby reducing positioning power consumption of the terminal.

Another specific embodiment is provided below. As shown in FIG. 2b, this embodiment includes the following steps.

Step 221: An AMF receives a location service request from a first terminal or an LCS entity, where the location service request includes a location request.

Step 222: The AMF selects a base station.

Step 223: The AMF sends the location request or power consumption requirement content in the location request to the base station. Correspondingly, the base station obtains the location request or the power consumption requirement content in the location request.

For example, there is step 224: The base station requests a terminal capability from the first terminal.

For example, there is step 225: The base station obtains the terminal capability of the first terminal, where the terminal capability includes first indication information.

Step 226: The base station initiates a positioning procedure based on at least one of the location request (or the power consumption requirement content in the location request) and the first indication information. For example, that the base station initiates a positioning procedure includes at least one of the following procedures, and there is no order between the following procedures:

The base station determines an appropriate positioning method based on a terminal characteristic of the first terminal and/or the location request, and sends a positioning method configuration to the first terminal.

The base station sends at least one of configuration information of RAN DRX and configuration information of RAN eDRX to the first terminal.

The base station sends at least one of downlink positioning reference signal configuration information, downlink positioning reference signal measurement window configuration information, and uplink positioning reference signal configuration information to the first terminal.

For example, there is step 227: The base station releases the first terminal to an inactive state or an idle state when the first terminal performs positioning.

Step 228: The first terminal measures a positioning reference signal, and/or reports a location estimation result, and/or sends an uplink positioning reference signal in a specific state (for example, the idle or inactive state) based on a configuration in a case of a specific DRX configuration (for example, after at least one of RAN DRX and RAN eDRX is configured).

Step 229: The base station obtains a measurement result or the location estimation result sent by the first terminal.

Step 2210: The base station sends the measurement result or the location estimation result to an LMF.

Step 2211: The LMF determines location information of the first terminal, and sends the location information to the AMF.

Step 2212: The AMF feeds back the location information to the first terminal or the LCS entity.

Another specific embodiment is provided below. As shown in FIG. 2c, this embodiment includes the following steps.

Step 231: An AMF receives a location service request from a first terminal or an LCS entity, where the location service request includes a location request.

For example, there is step 232: The AMF requests a terminal capability from the first terminal.

For example, there is step 233: The AMF obtains the terminal capability of the first terminal, where the terminal capability includes first indication information.

Step 234: The AMF initiates a positioning procedure based on at least one of the location request (or power consumption requirement content in the location request) and the first indication information. For example, that the AMF initiates a positioning procedure includes at least one of the following procedures, and there is no order between the following procedures: The AMF configures appropriate CN DRX and/or CN eDRX for the first terminal.

The AMF recommends an appropriate RAN DRX and/or RAN eDRX configuration to a base station, to assist the base station in configuring the RAN DRX and/or the RAN eDRX for the first terminal.

The AMF recommends an RRC state during positioning, for example, positioning measurement, positioning reporting, or sending of an uplink positioning reference signal, by the first terminal to the base station.

For example, there is step 235: The base station releases the first terminal to an inactive state or an idle state based on a request or a recommendation of the AMF when the first terminal performs positioning.

Step 236: The first terminal measures a positioning reference signal, and/or reports a location estimation result, and/or sends an uplink positioning reference signal in a specific state (for example, the idle or inactive state) based on a configuration in a case of a specific DRX configuration (for example, after at least one of CN DRX, CN eDRX, RAN DRX, and RAN eDRX is configured).

Step 237: An LMF obtains a measurement result or the location estimation result sent by the first terminal or the base station.

Step 238: The LMF determines location information of the first terminal, and sends the location information to the AMF.

Step 239: The AMF feeds back the location information to the first terminal or the LCS entity.

The positioning processing method provided in the embodiments of this application may be performed by a positioning processing apparatus. In the embodiments of this application, the positioning processing apparatus provided in the embodiments of this application is described by using an example in which the positioning processing apparatus performs the positioning processing method.

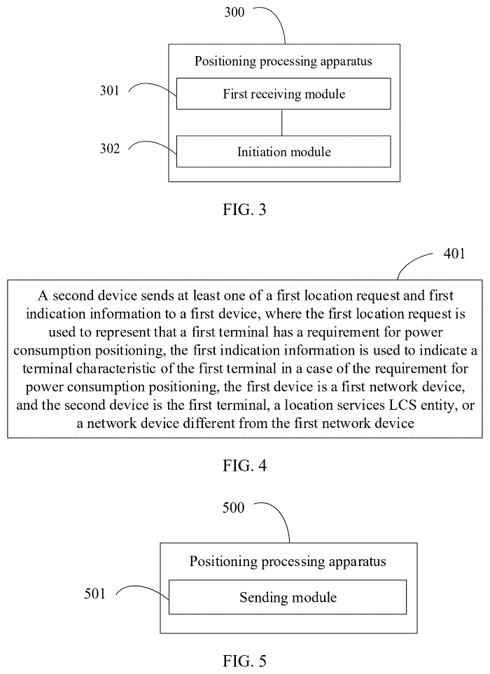

FIG. 3 is a structural diagram of a positioning processing apparatus according to an embodiment of this application. The positioning processing apparatus may be applied to a first device. As shown in FIG. 3, the positioning processing apparatus 300 includes:
a first receiving module 301, configured to receive at least one of a first location request and first indication information, where the first location request includes information used to indicate a requirement for power consumption positioning of a first terminal, the first indication information includes information used to indicate a terminal characteristic of the first terminal in a case of the requirement for power consumption positioning, and the first device is a first network device; and
an initiation module 302, configured to initiate a positioning procedure based on at least one of the first location request and the first indication information.

For example, both the first location request and the first indication information are sent by a second device to the first device, where the second device is the first terminal, a location services LCS entity, or a second network device; or
the first location request is sent by a third device to the first device, and the first indication information is sent by a fourth device to the first device, where the third device is the first terminal, a location services LCS entity, or a third network device, and the fourth device is the first terminal, a location services LCS entity, or a fourth network device.

For example, the first location request includes at least one of the following:
a service enable identifier for power consumption positioning;
battery information of the first terminal;
positioning service information of the first terminal;
power consumption information of the first terminal;
a positioning parameter for each time of positioning by the first terminal; and
a communication parameter for an overall communication service of the first terminal.

For example, the battery information of the first terminal includes at least one of the following:
a battery capacity parameter of the first terminal; and
a battery life requirement parameter of the first terminal;
and/or
the positioning service information of the first terminal includes at least one of the following:
a positioning service level parameter of the first terminal; and
positioning service type indication information of the first terminal;
and/or
the power consumption information of the first terminal includes at least one of the following:
a power level parameter of the first terminal; and
a parameter of a ratio of positioning power consumption of the first terminal to total power consumption of the first terminal;
and/or
the positioning parameter for each time of positioning by the first terminal includes at least one of the following:
a power consumption parameter for each time of positioning by the first terminal;
a peak power parameter for each time of positioning by the first terminal; and
an average power parameter for each time of positioning by the first terminal;
and/or
the communication parameter for the overall communication service of the first terminal includes at least one of the following:
a power consumption parameter for the overall communication service of the first terminal;
a peak power parameter for the overall communication service of the first terminal; and
an average power parameter for the overall communication service of the first terminal.

For example, the first indication information includes at least one of the following: information used to indicate a terminal characteristic that the first terminal performs positioning measurement in a non-connected state;
information used to indicate a terminal characteristic that the first terminal performs positioning reporting in the non-connected state;
information used to indicate a terminal characteristic that the first terminal sends an uplink positioning reference signal in the non-connected state; and
information used to indicate a terminal characteristic that a type of the first terminal is a low power high accuracy positioning LPHAP type or an internet of things IoT type.

For example, the first indication information is included in terminal capability information or terminal assistance information.

For example, the first indication information is indication information corresponding to the first terminal on a first frequency band; or
the first indication information is indication information corresponding to the first terminal in a first frequency range; or
the first indication information is indication information corresponding to a case in which the first terminal uses a first positioning method; or
the first indication information is indication information corresponding to a case in which the first terminal uses a first positioning method on a first frequency band; or
the first indication information is indication information corresponding to a case in which the first terminal uses a first positioning method in a first frequency range.

For example, the first device includes any one of an access and mobility management function AMF, a location management function LMF, and a base station.

For example, the first device is an AMF; and
the initiation module 302 includes at least one of the following:
a first sending unit, configured to send at least one of a second location request and second indication information to a fifth device, where the second location request includes information used to indicate the requirement for power consumption positioning of the first terminal, the second indication information includes information used to indicate the terminal characteristic of the first terminal in the case of the requirement for power consumption positioning, and the fifth device includes an LMF or a base station;
a second sending unit, configured to send first configuration information to the first terminal, where the first configuration information includes at least one of configuration information of a core network discontinuous reception CN DRX cycle and configuration information of a core network extended discontinuous reception CN eDRX cycle;
a third sending unit, configured to send a third message to the base station, where the third message is used to recommend at least one of configuration information of a radio access network discontinuous reception RAN DRX cycle and configuration information of a radio access network extended discontinuous reception RAN eDRX cycle to the base station; and
a fourth sending unit, configured to send a fourth message to the base station, where the fourth message is used to recommend a corresponding RRC state during positioning by the first terminal to the base station.

For example, the positioning processing apparatus 300 further includes:
a first sending module, configured to send a fifth message to the base station, where the fifth message includes at least one of CN DRX and CN eDRX configured by the first device for the first terminal; and
a second receiving module, configured to receive a sixth message sent by the base station, where the sixth message includes at least one of RAN DRX and RAN eDRX configured by the base station for the first terminal.

For example, the first device is an LMF; and
the initiation module 302 includes at least one of the following:
a fifth sending unit, configured to send at least one of a third location request and third indication information to a base station, where the third location request includes information used to indicate the requirement for power consumption positioning of the first terminal, and the third indication information includes information used to indicate the terminal characteristic of the first terminal in the case of the requirement for power consumption positioning;
a sixth sending unit, configured to send an eighth message to an AMF, where the eighth message is used to request the AMF to configure at least one of CN DRX and CN eDRX for the first terminal;
a seventh sending unit, configured to send a ninth message to the AMF, where the ninth message is used to recommend at least one of configuration information of CN DRX and configuration information of CN eDRX to the AMF;
an eighth sending unit, configured to send a tenth message to the base station, where the tenth message is used to request the base station to configure at least one of RAN DRX and RAN eDRX for the first terminal;
a ninth sending unit, configured to send an eleventh message to the base station, where the eleventh message is used to recommend at least one of configuration information of RAN DRX and configuration information of RAN eDRX to the base station;
a tenth sending unit, configured to send a twelfth message to a sixth device, where the twelfth message includes at least one of downlink positioning reference signal configuration information, positioning reporting configuration information, and positioning processing method configuration information that are determined by the first device, and the sixth device includes at least one of a base station and the first terminal;
an eleventh sending unit, configured to send a thirteenth message to the base station, where the thirteenth message is used to recommend uplink positioning reference signal configuration information to the base station; and
a twelfth sending unit, configured to send a fourteenth message to the base station, where the fourteenth message is used to recommend a corresponding RRC state during positioning by the first terminal to the base station.

For example, the positioning processing apparatus 300 further includes:
a second receiving module, configured to receive a fifteenth message sent by the AMF, where the fifteenth message includes at least one of CN DRX and CN eDRX configured by the AMF for the first terminal; and
a third receiving module, configured to receive a sixteenth message sent by the base station, where the sixteenth message includes at least one of RAN DRX and RAN eDRX configured by the base station for the first terminal.

For example, the first device is a base station; and
the initiation module 302 includes at least one of the following:
a thirteenth sending unit, configured to send a seventeenth message to an AMF, where the seventeenth message is used to request the AMF to configure at least one of CN DRX and CN eDRX for the first terminal;
a fourteenth sending unit, configured to send an eighteenth message to the AMF, where the eighteenth message is used to recommend at least one of configuration information of CN DRX and configuration information of CN eDRX to the AMF;
a fifteenth sending unit, configured to send second configuration information to the first terminal, where the second configuration information includes at least one of configuration information of RAN DRX and configuration information of RAN eDRX;
a sixteenth sending unit, configured to send third configuration information to the first terminal, where the third configuration information includes at least one of downlink positioning reference signal configuration information, downlink positioning reference signal measurement window configuration information, and uplink positioning reference signal configuration information; and
a switching unit, configured to switch an RRC state of the first terminal to an idle state or an inactive state.

For example, the positioning processing apparatus 300 further includes:
a fourth receiving module, configured to receive a nineteenth message sent by the AMF, where the nineteenth message includes at least one of CN DRX and CN eDRX configured by the AMF for the first terminal; and
a second sending module, configured to send a twentieth message to an LMF, where the twentieth message includes at least one of RAN DRX and RAN eDRX configured by the first device for the first terminal.

In conclusion, in this embodiment of this application, through the foregoing implementation, the first device may accurately initiate the positioning procedure corresponding to the requirement for power consumption positioning based on the first location request and/or the first indication information. Because the first device can accurately initiate the positioning procedure corresponding to the requirement for power consumption positioning, the terminal can accurately perform positioning, thereby reducing positioning power consumption of the terminal.

The positioning processing apparatus in this embodiment of this application may be an electronic device, for example, an electronic device with an operating system, or may be a component, for example, an integrated circuit or a chip, in an electronic device. The electronic device may be a terminal, or may be a device other than a terminal. For example, the terminal may include but is not limited to the foregoing listed type of the terminal 11, and the another device may be a server, a Network Attached Storage (NAS), or the like. This is not specifically limited in this embodiment of this application.

The positioning processing apparatus provided in this embodiment of this application can implement the processes implemented in the method embodiment in FIG. 2, and achieve same technical effects. To avoid repetition, details are not described herein again.

FIG. 4 is a flowchart of a positioning processing method according to an embodiment of this application. As shown in FIG. 4, the positioning processing method includes the following steps.

Step 401: A second device sends at least one of a first location request and first indication information to a first device, where the first location request is used to represent that a first terminal has a requirement for power consumption positioning, the first indication information is used to indicate a terminal characteristic of the first terminal in a case of the requirement for power consumption positioning, the first device is a first network device, and the second device is the first terminal, a location services LCS entity, or a network device different from the first network device.

For example, the first location request includes at least one of the following:
a service enable identifier for power consumption positioning;
battery information of the first terminal;
positioning service information of the first terminal;
power consumption information of the first terminal;
a positioning parameter for each time of positioning by the first terminal; and
a communication parameter for an overall communication service of the first terminal.

For example, the battery information of the first terminal includes at least one of the following:
a battery capacity parameter of the first terminal; and
a battery life requirement parameter of the first terminal;
and/or
the positioning service information of the first terminal includes at least one of the following:
a positioning service level parameter of the first terminal; and
positioning service type indication information of the first terminal;
and/or
the power consumption information of the first terminal includes at least one of the following:
a power level parameter of the first terminal; and
a parameter of a ratio of positioning power consumption of the first terminal to total power consumption of the first terminal;
and/or
the positioning parameter for each time of positioning by the first terminal includes at least one of the following:
a power consumption parameter for each time of positioning by the first terminal;
a peak power parameter for each time of positioning by the first terminal; and
an average power parameter for each time of positioning by the first terminal;
and/or
the communication parameter for the overall communication service of the first terminal includes at least one of the following:
a power consumption parameter for the overall communication service of the first terminal;
a peak power parameter for the overall communication service of the first terminal; and
an average power parameter for the overall communication service of the first terminal.

For example, the first indication information includes at least one of the following: information used to indicate a terminal characteristic that the first terminal performs positioning measurement in a non-connected state;
information used to indicate a terminal characteristic that the first terminal performs positioning reporting in the non-connected state;
information used to indicate a terminal characteristic that the first terminal sends an uplink positioning reference signal in the non-connected state; and
information used to indicate a terminal characteristic that a type of the first terminal is a low power high accuracy positioning LPHAP type or an internet of things IoT type.

For example, the first indication information is included in terminal capability information or terminal assistance information.

For example, the first indication information is indication information corresponding to the first terminal on a first frequency band; or
the first indication information is indication information corresponding to the first terminal in a first frequency range; or
the first indication information is indication information corresponding to a case in which the first terminal uses a first positioning method; or
the first indication information is indication information corresponding to a case in which the first terminal uses a first positioning method on a first frequency band; or
the first indication information is indication information corresponding to a case in which the first terminal uses a first positioning method in a first frequency range.

For example, the first device includes any one of an access and mobility management function AMF, a location management function LMF, and a base station.

For example, the second device is the first terminal; and
the method further includes at least one of the following:
The second device receives first configuration information sent by an AMF, where the first configuration information includes at least one of configuration information of a core network discontinuous reception CN DRX cycle and configuration information of a core network extended discontinuous reception CN eDRX cycle;
the second device receives second configuration information sent by a base station, where the second configuration information includes at least one of configuration information of a radio access network discontinuous reception RAN DRX cycle and configuration information of a radio access network extended discontinuous reception RAN eDRX cycle;
the second device receives third configuration information sent by the base station, where the third configuration information includes at least one of downlink positioning reference signal configuration information, downlink positioning reference signal measurement window configuration information, and uplink positioning reference signal configuration information; and
the second device receives a twelfth message sent by an LMF, where the twelfth message includes at least one of downlink positioning reference signal configuration information, positioning reporting configuration information, and positioning processing method configuration information that are determined by the LMF.

In this embodiment of this application, the second device sends the first location request and/or the first indication information to the first device, and the first device may accurately initiate a positioning procedure corresponding to the requirement for power consumption positioning based on the first location request and/or the first indication information. Because the first device can accurately initiate the positioning procedure corresponding to the requirement for power consumption positioning, the terminal can accurately perform positioning, thereby reducing positioning power consumption of the terminal.

For related descriptions of this embodiment of this application, refer to the related descriptions of the method embodiment in FIG. 2. To avoid repetition, details are not described again.

The positioning processing method provided in the embodiments of this application may be performed by a positioning processing apparatus. In the embodiments of this application, the positioning processing apparatus provided in the embodiments of this application is described by using an example in which the positioning processing apparatus performs the positioning processing method.

FIG. 5 is a structural diagram of a positioning processing apparatus according to an embodiment of this application. The positioning processing apparatus may be applied to a second device. As shown in FIG. 5, the positioning processing apparatus 500, includes:
a sending module 501, configured to send at least one of a first location request and first indication information to a first device, where the first location request is used to represent that a first terminal has a requirement for power consumption positioning, the first indication information is used to indicate a terminal characteristic of the first terminal in a case of the requirement for power consumption positioning, the first device is a first network device, and the second device is the first terminal, a location services LCS entity, or a network device different from the first network device.

For example, the first location request includes at least one of the following:
a service enable identifier for power consumption positioning;
battery information of the first terminal;
positioning service information of the first terminal;
power consumption information of the first terminal;
a positioning parameter for each time of positioning by the first terminal; and
a communication parameter for an overall communication service of the first terminal.

For example, the battery information of the first terminal includes at least one of the following:
a battery capacity parameter of the first terminal; and
a battery life requirement parameter of the first terminal;
and/or
the positioning service information of the first terminal includes at least one of the following:
a positioning service level parameter of the first terminal; and
positioning service type indication information of the first terminal;
and/or
the power consumption information of the first terminal includes at least one of the following:
a power level parameter of the first terminal; and
a parameter of a ratio of positioning power consumption of the first terminal to total power consumption of the first terminal;
and/or
the positioning parameter for each time of positioning by the first terminal includes at least one of the following:
a power consumption parameter for each time of positioning by the first terminal;
a peak power parameter for each time of positioning by the first terminal; and
an average power parameter for each time of positioning by the first terminal;
and/or
the communication parameter for the overall communication service of the first terminal includes at least one of the following:
a power consumption parameter for the overall communication service of the first terminal;
a peak power parameter for the overall communication service of the first terminal; and
an average power parameter for the overall communication service of the first terminal.

For example, the first indication information includes at least one of the following:
information used to indicate a terminal characteristic that the first terminal performs positioning measurement in a non-connected state;
information used to indicate a terminal characteristic that the first terminal performs positioning reporting in the non-connected state;
information used to indicate a terminal characteristic that the first terminal sends an uplink positioning reference signal in the non-connected state; and
information used to indicate a terminal characteristic that a type of the first terminal is a low power high accuracy positioning LPHAP type or an internet of things IoT type.

For example, the first indication information is included in terminal capability information or terminal assistance information.

For example, the first indication information is indication information corresponding to the first terminal on a first frequency band; or
the first indication information is indication information corresponding to the first terminal in a first frequency range; or
the first indication information is indication information corresponding to a case in which the first terminal uses a first positioning method; or
the first indication information is indication information corresponding to a case in which the first terminal uses a first positioning method on a first frequency band; or
the first indication information is indication information corresponding to a case in which the first terminal uses a first positioning method in a first frequency range.

For example, the first device includes any one of an access and mobility management function AMF, a location management function LMF, and a base station.

For example, the second device is the first terminal; and
the positioning processing apparatus 500 further includes at least one of the following:
a first receiving module, configured to receive first configuration information sent by an AMF, where the first configuration information includes at least one of configuration information of a core network discontinuous reception CN DRX cycle and configuration information of a core network extended discontinuous reception CN eDRX cycle;
a second receiving module, configured to receive second configuration information sent by a base station, where the second configuration information includes at least one of configuration information of a radio access network discontinuous reception RAN DRX cycle and configuration information of a radio access network extended discontinuous reception RAN eDRX cycle;
a third receiving module, configured to receive third configuration information sent by the base station, where the third configuration information includes at least one of downlink positioning reference signal configuration information, downlink positioning reference signal measurement window configuration information, and uplink positioning reference signal configuration information; and
a fourth receiving module, configured to receive a twelfth message sent by an LMF, where the twelfth message includes at least one of downlink positioning reference signal configuration information, positioning reporting configuration information, and positioning processing method configuration information that are determined by the LMF.

In this embodiment of this application, the second device sends the first location request and/or the first indication information to the first device, and the first device may accurately initiate a positioning procedure corresponding to the requirement for power consumption positioning based on the first location request and/or the first indication information. Because the first device can accurately initiate the positioning procedure corresponding to the requirement for power consumption positioning, the terminal can accurately perform positioning, thereby reducing positioning power consumption of the terminal.

The positioning processing apparatus in this embodiment of this application may be an electronic device, for example, an electronic device with an operating system, or may be a component, for example, an integrated circuit or a chip, in an electronic device. The electronic device may be a terminal, or may be a device other than a terminal. For example, the terminal may include but is not limited to the foregoing listed type of the terminal 11, and the another device may be a server, a NAS, or the like. This is not specifically limited in this embodiment of this application.

The positioning processing apparatus provided in this embodiment of this application can implement the processes implemented in the method embodiment in FIG. 4, and achieve same technical effects. To avoid repetition, details are not described herein again.

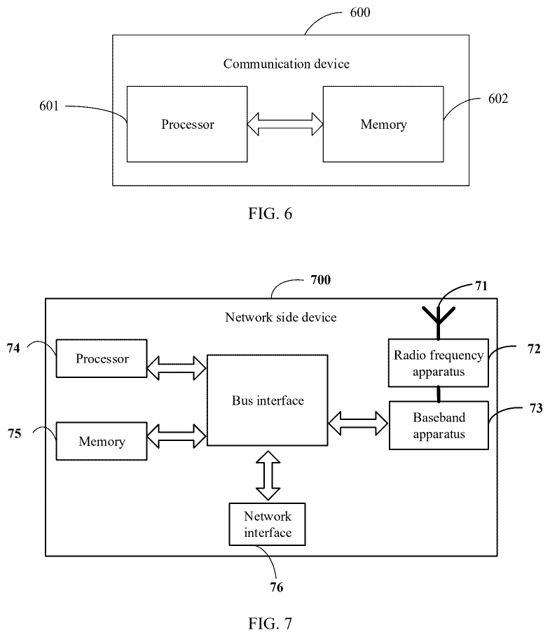

For example, as shown in FIG. 6, an embodiment of this application further provides a communication device 600, including a processor 601 and a memory 602. The memory 602 stores a program or instructions capable of being run on the processor 601. For example, when the communication device 600 is a first device (for example, may be a network device such as an AMF, an LMF, or a base station), and the program or the instructions are executed by the processor 601, the steps in the foregoing positioning processing method embodiment are implemented, and same technical effects can be achieved. When the communication device 600 is a second device (for example, may be a communication device such as a first terminal, an LCS entity, or a network device), and the program or the instructions are executed by the processor 601, the steps in the foregoing positioning processing method embodiment are implemented, and same technical effects can be achieved. To avoid repetition, details are not described herein again.

An embodiment of this application further provides a first device, including a processor and a communication interface. The communication interface is configured to receive at least one of a first location request and first indication information, where the first location request includes information used to indicate a requirement for power consumption positioning of a first terminal, the first indication information includes information used to indicate a terminal characteristic of the first terminal in a case of the requirement for power consumption positioning, and the first device is a first network device. The processor or the communication interface is configured to initiate a positioning procedure based on at least one of the first location request and the first indication information. The first device embodiment corresponds to the foregoing first device-side method embodiment. Each implementation process and implementation in the foregoing method embodiment can be applied to the first device embodiment, and same technical effects can be achieved.

For example, an embodiment of this application further provides a network device. The network device may be a base station. As shown in FIG. 7, the network device 700 includes an antenna 71, a radio frequency apparatus 72, a baseband apparatus 73, a processor 74, and a memory 75. The antenna 71 is connected to the radio frequency apparatus 72. In an uplink direction, the radio frequency apparatus 72 receives information through the antenna 71, and sends the received information to the baseband apparatus 73 for processing. In a downlink direction, the baseband apparatus 73 processes to-be-sent information, and sends processed information to the radio frequency apparatus 72. The radio frequency apparatus 72 processes the received information, and then sends processed information through the antenna 71.

The method performed by the network device in the foregoing embodiment may be implemented in the baseband apparatus 73. The baseband apparatus 73 includes a baseband processor.

For example, the baseband apparatus 73 may include at least one baseband board, and a plurality of chips are disposed on the baseband board. As shown in FIG. 7, one of the chips is, for example, a baseband processor, and is connected to the memory 75 through a bus interface, to invoke a program in the memory 75 to perform a network device operation shown in the foregoing method embodiment.

The network device may further include a network interface 76, and the interface is, for example, a Common Public Radio Interface (CPRI).

For example, the network device 700 in this embodiment of the present disclosure further includes instructions or a program stored in the memory 75 and capable of being run on the processor 74. The processor 74 invokes the instructions or the program in the memory 75 to perform the method performed by the modules shown in FIG. 3, and same technical effects are achieved. To avoid repetition, details are not described herein again.

For example, an embodiment of this application further provides another network device. The network device may be an AMF or an LMF. As shown in FIG. 8, the network device 800 includes a processor 801, a network interface 802, and a memory 803. The network interface 802 is, for example, a CPRI.

For example, the network device 800 in this embodiment of the present disclosure further includes instructions or a program stored in the memory 803 and capable of being run on the processor 801. The processor 801 invokes the instructions or the program in the memory 803 to perform the method performed by the modules shown in FIG. 3, and same technical effects are achieved. To avoid repetition, details are not described herein again.

An embodiment of this application further provides a second device, including a processor and a communication interface. The communication interface is configured to send at least one of a first location request and first indication information to a first device, where the first location request includes information used to indicate a requirement for power consumption positioning of a first terminal, the first indication information includes information used to indicate a terminal characteristic of the first terminal in a case of the requirement for power consumption positioning, the first device is a first network device, and the second device is the first terminal, a location services LCS entity, or a network device different from the first network device. The second device embodiment corresponds to the foregoing second device-side method embodiment. Each implementation process and implementation in the foregoing method embodiment can be applied to the second device embodiment, and same technical effects can be achieved.

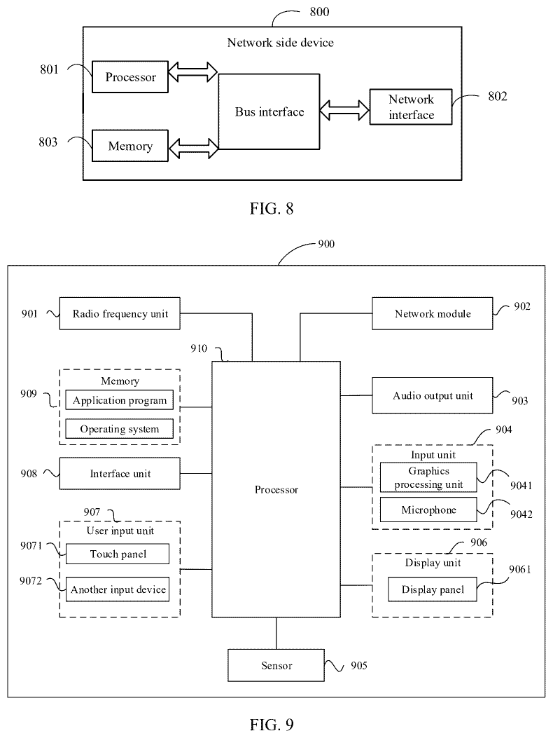

An example in which a second device is a first terminal is used below. For example, FIG. 9 is a schematic diagram of a hardware structure of a first terminal for implementing an embodiment of this application.

The first terminal 900 includes but is not limited to at least some of a radio frequency unit 901, a network module 902, an audio output unit 903, an input unit 904, a sensor 905, a display unit 906, a user input unit 907, an interface unit 908, a memory 909, a processor 910, and the like.

A person skilled in the art may understand that the first terminal 900 may further include a power supply (for example, a battery) that supplies power to each component, and the power supply may be logically connected to the processor 910 through a power management system, to implement functions such as charging management, discharging management, and power consumption management through the power management system. The terminal structure shown in FIG. 9 does not constitute a limitation on the terminal. The terminal may include more or fewer components than those shown in the figure, some components may be combined, or different component arrangements may be used. Details are not described herein again.

It should be understood that in this embodiment of this application, the input unit 904 may include a Graphics Processing Unit (GPU) 9041 and a microphone 9042. The graphics processing unit 9041 processes image data of a still picture or video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a function key (for example, a volume control key or an on/off key), a trackball, a mouse, or a joystick. Details are not described herein again.

In this embodiment of this application, after receiving downlink data from a network device, the radio frequency unit 901 may transmit the downlink data to the processor 910 for processing. In addition, the radio frequency unit 901 may send uplink data to the network device. Usually, the radio frequency unit 901 includes but is not limited to an antenna, an amplifier, a transceiver, a coupler, a low noise amplifier, a duplexer, or the like.

The memory 909 may be configured to store a software program or instructions and various types of data. The memory 909 may mainly include a first storage area for storing a program or instructions and a second storage area for storing data. The first storage area may store an operating system, an application program or instructions required by at least one function (for example, a sound play function or an image play function), and the like. In addition, the memory 909 may include a volatile memory or a nonvolatile memory, or the memory 909 may include both a volatile memory and a nonvolatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DRRAM). The memory 909 in this embodiment of this application includes but is not limited to these memories and any memory of another appropriate type.

The processor 910 may include one or more processing units. For example, an application processor and a modem processor are integrated into the processor 910. The application processor mainly processes operations related to an operating system, a user interface, an application program, and the like, and the modem processor mainly processes a wireless communication signal, for example, a baseband processor. It may be understood that the modem processor may not be integrated into the processor 910.

The radio frequency unit 901 is configured to:
send at least one of a first location request and first indication information to a first device, where the first location request includes information used to indicate a requirement for power consumption positioning of a first terminal, the first indication information includes information used to indicate a terminal characteristic of the first terminal in a case of the requirement for power consumption positioning, the first device is a first network device, and the second device is the first terminal.

In this embodiment of this application, the second device sends the first location request and/or the first indication information to the first device, and the first device may accurately initiate a positioning procedure corresponding to the requirement for power consumption positioning based on the first location request and/or the first indication information. Because the first device can accurately initiate the positioning procedure corresponding to the requirement for power consumption positioning, the terminal can accurately perform positioning, thereby reducing positioning power consumption of the terminal.

For example, the first location request includes at least one of the following:
a service enable identifier for power consumption positioning;
battery information of the first terminal;
positioning service information of the first terminal;
power consumption information of the first terminal;
a positioning parameter for each time of positioning by the first terminal; and
a communication parameter for an overall communication service of the first terminal.

For example, the battery information of the first terminal includes at least one of the following:
a battery capacity parameter of the first terminal; and
a battery life requirement parameter of the first terminal;
and/or
the positioning service information of the first terminal includes at least one of the following:
a positioning service level parameter of the first terminal; and
positioning service type indication information of the first terminal;
and/or
the power consumption information of the first terminal includes at least one of the following:
a power level parameter of the first terminal; and
a parameter of a ratio of positioning power consumption of the first terminal to total power consumption of the first terminal;
and/or
the positioning parameter for each time of positioning by the first terminal includes at least one of the following:
a power consumption parameter for each time of positioning by the first terminal;
a peak power parameter for each time of positioning by the first terminal; and
an average power parameter for each time of positioning by the first terminal;
and/or
the communication parameter for the overall communication service of the first terminal includes at least one of the following:
a power consumption parameter for the overall communication service of the first terminal;
a peak power parameter for the overall communication service of the first terminal; and
an average power parameter for the overall communication service of the first terminal.

For example, the first indication information includes at least one of the following:
information used to indicate a terminal characteristic that the first terminal performs positioning measurement in a non-connected state;
information used to indicate a terminal characteristic that the first terminal performs positioning reporting in the non-connected state;
information used to indicate a terminal characteristic that the first terminal sends an uplink positioning reference signal in the non-connected state; and
information used to indicate a terminal characteristic that a type of the first terminal is a low power high accuracy positioning LPHAP type or an internet of things IoT type.

For example, the first indication information is included in terminal capability information or terminal assistance information.

For example, the first indication information is indication information corresponding to the first terminal on a first frequency band; or
the first indication information is indication information corresponding to the first terminal in a first frequency range; or
the first indication information is indication information corresponding to a case in which the first terminal uses a first positioning method; or
the first indication information is indication information corresponding to a case in which the first terminal uses a first positioning method on a first frequency band; or
the first indication information is indication information corresponding to a case in which the first terminal uses a first positioning method in a first frequency range.

For example, the first device includes any one of an access and mobility management function AMF, a location management function LMF, and a base station.

For example, the first device is an AMF; and
the radio frequency unit 901 is further configured to perform at least one of the following:
receiving first configuration information sent by an AMF, where the first configuration information includes at least one of configuration information of a core network discontinuous reception CN DRX cycle and configuration information of a core network extended discontinuous reception CN eDRX cycle;
receiving second configuration information sent by a base station, where the second configuration information includes at least one of configuration information of a radio access network discontinuous reception RAN DRX cycle and configuration information of a radio access network extended discontinuous reception RAN eDRX cycle;
receiving third configuration information sent by the base station, where the third configuration information includes at least one of downlink positioning reference signal configuration information, downlink positioning reference signal measurement window configuration information, and uplink positioning reference signal configuration information; and
receiving a twelfth message sent by an LMF, where the twelfth message includes at least one of downlink positioning reference signal configuration information, positioning reporting configuration information, and positioning processing method configuration information that are determined by the LMF.

In conclusion, in this embodiment of this application, through the foregoing implementation, positioning power consumption of the terminal can be reduced.

An embodiment of this application further provides a readable storage medium. The readable storage medium stores a program or instructions. When the program or the instructions are executed by a processor, the processes in the foregoing positioning processing method embodiment are implemented, and same technical effects can be achieved. To avoid repetition, details are not described herein again.

The processor is a processor in the terminal in the foregoing embodiment. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing positioning processing method embodiment, and same technical effects can be achieved. To avoid repetition, details are not described herein again.

It should be understood that the chip described in this embodiment of this application may also be referred to as a system-level chip, a system chip, a chip system, a system-on-a-chip, or the like.

An embodiment of this application further provides a computer program/program product. The computer program/program product is stored in a storage medium. The computer program/program product is executed by at least one processor to implement the processes in the foregoing positioning processing method embodiment, and same technical effects can be achieved. To avoid repetition, details are not described herein again.

An embodiment of this application further provides a communication system, including a first device and a second device. The first device may be a network device, and the second device may be a terminal, an LCS entity, or a network device. The first device may be configured to perform the steps of the positioning processing method described above, and the second device may be configured to perform the steps of the positioning processing method described above.

It should be noted that in this specification, the terms “include”, “comprise”, or any other variants thereof are intended to cover a non-exclusive inclusion, so that a process, a method, an article, or an apparatus that includes a list of elements not only includes those elements but also includes other elements that are not expressly listed, or further includes elements inherent to such a process, method, article, or apparatus. Without more constraints, an element preceded by “includes a . . . ” does not preclude the presence of additional identical elements in the process, method, article, or apparatus that includes the element. In addition, it should be noted that the scope of the method and the apparatus in the implementations of this application is not limited to performing functions in the shown or described order, and may further include performing functions in a substantially simultaneous manner or in a reverse order based on the functions involved. For example, the described method may be performed in an order different from the described order, and various steps may be added, omitted, or combined. In addition, features described with reference to some examples may be combined in other examples.

Based on the foregoing descriptions of the implementations, a person skilled in the art may clearly understand that the method in the foregoing embodiments may be implemented by using software and a necessary general-purpose hardware platform, or may be implemented by using hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings. However, this application is not limited to the foregoing specific implementations. The foregoing specific implementations are merely examples, and are not limiting. Many forms that can be made by a person of ordinary skill in the art based on the teachings of this application without departing from the objective and the protection scope of the claims of this application shall fall within the protection scope of this application.

1. A positioning processing method, comprising:
receiving, by a first device, a first location request, wherein the first location request comprises information used to indicate a requirement for power consumption positioning of a first terminal, the first device is a first network device; and
initiating, by the first device, a positioning procedure corresponding to the requirement based on the first location request.

2. The positioning processing method according to claim 1, wherein the receiving, by a first device, a first location request comprises:
receiving, by the first device, the first location request from a second device, wherein the second device is a second network device.

3. The positioning processing method according to claim 1, wherein the first location request comprises at least one of the following:
positioning service information of the first terminal;
a service enable identifier for power consumption positioning;
battery information of the first terminal;
power consumption information of the first terminal;
a positioning parameter for each time of positioning by the first terminal; or
a communication parameter for an overall communication service of the first terminal.

4. The positioning processing method according to claim 3, wherein the battery information of the first terminal comprises at least one of the following:
a battery capacity parameter of the first terminal; or
a battery life requirement parameter of the first terminal,
or
the positioning service information of the first terminal comprises at least one of the following:
a positioning service level parameter of the first terminal; or
positioning service type indication information of the first terminal, wherein the positioning service type indication information indicates that a positioning service type of the first terminal is an LPHAP service type;
or
the power consumption information of the first terminal comprises at least one of the following:
a power level parameter of the first terminal; or
a parameter of a ratio of positioning power consumption of the first terminal to total power consumption of the first terminal,
or
the positioning parameter for each time of positioning by the first terminal comprises at least one of the following:
a power consumption parameter for each time of positioning by the first terminal;
a peak power parameter for each time of positioning by the first terminal; or
an average power parameter for each time of positioning by the first terminal,
or
the communication parameter for the overall communication service of the first terminal comprises at least one of the following:
a power consumption parameter for the overall communication service of the first terminal;
a peak power parameter for the overall communication service of the first terminal; or
an average power parameter for the overall communication service of the first terminal.

5. The positioning processing method according to claim 1, wherein the first device is an Access and Mobility Management Function (AMF),
the initiating, by the first device, the positioning procedure comprises at least one of the following:
sending, by the first device, at least one of a second location request or second indication information to a fifth device, wherein the second location request comprises information used to indicate the requirement for power consumption positioning of the first terminal, the second indication information comprises information used to indicate the terminal characteristic of the first terminal in response to the requirement for power consumption positioning, the fifth device comprises an Location Management Function (LMF) or a base station;
sending, by the first device, first configuration information to the first terminal, wherein the first configuration information comprises at least one of configuration information of a Core Network Discontinuous Reception (CN DRX) cycle or configuration information of a Core Network extended Discontinuous Reception (CN eDRX) cycle;
sending, by the first device, a third message to the base station, wherein the third message is used to recommend at least one of configuration information of a Radio Access Network Discontinuous Reception (RAN DRX) cycle or configuration information of a Radio Access Network extended Discontinuous Reception (RAN eDRX) cycle to the base station; or
sending, by the first device, a fourth message to the base station, wherein the fourth message is used to recommend a corresponding Radio Resource Control (RRC) state during positioning by the first terminal to the base station.

6. The positioning processing method according to claim 5, further comprising at least one of the following:
sending, by the first device, a fifth message to the base station, wherein the fifth message comprises at least one of CN DRX or CN eDRX configured by the first device for the first terminal; or
receiving, by the first device, a sixth message sent by the base station, wherein the sixth message comprises at least one of RAN DRX or RAN eDRX configured by the base station for the first terminal.

7. The positioning processing method according to claim 1, wherein the first device is an LMF,
the initiating, by the first device, a positioning procedure corresponding to the requirement based on the first location request comprises:
sending, by the first device, a third location request to a base station, wherein the third location request comprises information used to indicate the requirement for power consumption positioning of the first terminal.

8. The positioning processing method according to claim 7, further comprising:
determining, by the first device, an appropriate positioning method, based on the first location request.

9. The positioning processing method according to claim 1, wherein the first device is a base station,
the initiating, by the first device, a positioning procedure corresponding to the requirement comprises at least one of the following:
sending, by the first device, a seventeenth message to an AMF, wherein the seventeenth message is used to request the AMF to configure at least one of CN DRX or CN eDRX for the first terminal;
sending, by the first device, an eighteenth message to the AMF, wherein the eighteenth message is used to recommend at least one of configuration information of CN DRX or configuration information of CN eDRX to the AMF;
sending, by the first device, second configuration information to the first terminal, wherein the second configuration information comprises at least one of configuration information of RAN DRX or configuration information of RAN eDRX;
sending, by the first device, third configuration information to the first terminal, wherein the third configuration information comprises at least one of downlink positioning reference signal configuration information, downlink positioning reference signal measurement window configuration information, or uplink positioning reference signal configuration information; or
switching, by the first device, an RRC state of the first terminal to an idle state or an inactive state.

10. The positioning processing method according to claim 9, further comprising at least one of the following:
receiving, by the first device, a nineteenth message sent by the AMF, wherein the nineteenth message comprises at least one of CN DRX or CN eDRX configured by the AMF for the first terminal; or
sending, by the first device, a twentieth message to an LMF, wherein the twentieth message comprises at least one of RAN DRX or RAN eDRX configured by the first device for the first terminal.

11. A positioning processing method, comprising:
sending, by a second device, a first location request, wherein the first location request comprises information used to indicate a requirement for power consumption positioning of a first terminal, the first device is a first network device, the second device is a network device different from the first network device.

12. The positioning processing method according to claim 11, wherein the first location request comprises at least one of the following:
positioning service information of the first terminal;
a service enable identifier for power consumption positioning;
battery information of the first terminal;
power consumption information of the first terminal;
a positioning parameter for each time of positioning by the first terminal; or
a communication parameter for an overall communication service of the first terminal.

13. The positioning processing method according to claim 12, wherein the battery information of the first terminal comprises at least one of the following:
a battery capacity parameter of the first terminal; or
a battery life requirement parameter of the first terminal,
or
the positioning service information of the first terminal comprises at least one of the following:
a positioning service level parameter of the first terminal; or
positioning service type indication information of the first terminal, wherein the positioning service type indication information indicates that a positioning service type of the first terminal is an LPHAP service type;
or
the power consumption information of the first terminal comprises at least one of the following:
a power level parameter of the first terminal; or
a parameter of a ratio of positioning power consumption of the first terminal to total power consumption of the first terminal,
or
the positioning parameter for each time of positioning by the first terminal comprises at least one of the following:
a power consumption parameter for each time of positioning by the first terminal;
a peak power parameter for each time of positioning by the first terminal; or
an average power parameter for each time of positioning by the first terminal,
or
the communication parameter for the overall communication service of the first terminal comprises at least one of the following:
a power consumption parameter for the overall communication service of the first terminal;
a peak power parameter for the overall communication service of the first terminal; or
an average power parameter for the overall communication service of the first terminal.

14. A first device, comprising a processor and a memory storing instructions, wherein the instructions, when executed by the processor, cause the processor to perform operations comprising:
receiving a first location request, wherein the first location request comprises information used to indicate a requirement for power consumption positioning of a first terminal, the first device is a first network device; and
initiating a positioning procedure corresponding to the requirement based on the first location request.

15. The first device according to claim 14, wherein the receiving a first location request comprises:
receiving the first location request from a second device, wherein the second device is a second network device.

16. The first device according to claim 14, wherein the first location request comprises at least one of the following:
positioning service information of the first terminal;
a service enable identifier for power consumption positioning;
battery information of the first terminal;
power consumption information of the first terminal;
a positioning parameter for each time of positioning by the first terminal; or
a communication parameter for an overall communication service of the first terminal.

17. The first device according to claim 16, wherein the battery information of the first terminal comprises at least one of the following:
a battery capacity parameter of the first terminal; or
a battery life requirement parameter of the first terminal,
or
the positioning service information of the first terminal comprises at least one of the following:
a positioning service level parameter of the first terminal; or
positioning service type indication information of the first terminal, wherein the positioning service type indication information indicates that a positioning service type of the first terminal is an LPHAP service type;
or
the power consumption information of the first terminal comprises at least one of the following:
a power level parameter of the first terminal; or
a parameter of a ratio of positioning power consumption of the first terminal to total power consumption of the first terminal,
or
the positioning parameter for each time of positioning by the first terminal comprises at least one of the following:
a power consumption parameter for each time of positioning by the first terminal;
a peak power parameter for each time of positioning by the first terminal; or
an average power parameter for each time of positioning by the first terminal, or
the communication parameter for the overall communication service of the first terminal comprises at least one of the following:
a power consumption parameter for the overall communication service of the first terminal;
a peak power parameter for the overall communication service of the first terminal; or
an average power parameter for the overall communication service of the first terminal.

18. The first device according to claim 14, wherein the first device is an LMF,
the initiating a positioning procedure corresponding to the requirement based on the first location request comprises:
sending a third location request to a base station, wherein the third location request comprises information used to indicate the requirement for power consumption positioning of the first terminal.

19. The first device according to claim 18, wherein the instructions, when executed by the processor, cause the processor to perform operations further comprising:
determining, by the first device, an appropriate positioning method, based on the first location request.

20. The first device according to claim 14, wherein the first device is a base station,
the initiating, by the first device, a positioning procedure corresponding to the requirement comprises at least one of the following:
sending, by the first device, a seventeenth message to an AMF, wherein the seventeenth message is used to request the AMF to configure at least one of CN DRX or CN eDRX for the first terminal;
sending, by the first device, an eighteenth message to the AMF, wherein the eighteenth message is used to recommend at least one of configuration information of CN DRX or configuration information of CN eDRX to the AMF;
sending, by the first device, second configuration information to the first terminal, wherein the second configuration information comprises at least one of configuration information of RAN DRX or configuration information of RAN eDRX;
sending, by the first device, third configuration information to the first terminal, wherein the third configuration information comprises at least one of downlink positioning reference signal configuration information, downlink positioning reference signal measurement window configuration information, or uplink positioning reference signal configuration information; or
switching, by the first device, an RRC state of the first terminal to an idle state or an inactive state.
